(19) United States
(12) Patent Application Publication
(10) Pub. No.: US 2025/0376216 A1
(43) Pub. Date: Dec. 11, 2025

(54) LOWER STRUCTURE OF VEHICLE

(71) Applicant: MAZDA MOTOR CORPORATION, Hiroshima (JP)

(72) Inventors: Eiji KAMEMOTO, Aki-gun (JP); Hideyuki TSUKAMOTO, Aki-gun (JP); Hirotaka NATSUME, Aki-gun (JP); Takehiro KAMEI, Aki-gun (JP)

(73) Assignee: MAZDA MOTOR CORPORATION, Hiroshima (JP)

(21) Appl. No.: 19/171,949

(22) Filed: Apr. 7, 2025

(30) Foreign Application Priority Data
Jun. 7, 2024 (JP) 2024-093032

(51) Int. Cl. B62D 21/03; B62D 21/15

(52) U.S. Cl. CPC B62D 21/03; B62D 21/15

(57) ABSTRACT

A pair of right-and-left side sills extending in a vehicle longitudinal direction and having a closed-cross section, a cross member extending in a vehicle width direction between the side sills, and a reinforcement extending in the vehicle longitudinal direction inside the closed-cross section of each of the pair of side sills are provided. The reinforcement includes a pair of upper-and-lower lateral wall portions expanding in the vehicle longitudinal direction and in a vehicle width direction and a pair of right-and-left vertical wall portions connecting, in a vertical direction, respective right-side end portions of the pair of lateral wall portions and respective left-side end portions of the pair of lateral wall portions, and the lateral wall portions have plural first ridgeline portions extending in the vehicle width direction, respectively.

### BACKGROUND OF THE INVENTION

The present invention relates to a lower structure of a vehicle.

It has been considered to arrange a reinforcing member inside a side sill as countermeasures for a pole side-collision of a vehicle.

Japanese Patent Laid-Open Publication No. 2021-024350, for example, discloses a vehicle-body structure in which a reinforcing member having a continuous-cylindrical structure in which plural polygonal-shaped closed-cross sections are continuous when viewed in a vehicle width direction and a deformation-control member to control deformation, in a vehicle longitudinal direction, of the continuous-cylindrical structure of the reinforcing member are arranged inside a side sill extending in a vehicle longitudinal direction.

In the vehicle-body structure of the above-described patent document, the load (load-bearing) capacity along the vehicle width direction is improved by the cylindrical structure of the reinforcement. However, if a whole part of the reinforcement is constituted by the cylindrical structure, a gross area of the reinforcement becomes too large, and therefore the vehicle-body weight may increase improperly.

### SUMMARY OF THE INVENTION

The present invention has been devised in view of the above-described matter and an object of the present invention is to provide a lower structure of a vehicle which can properly improve the absorption amount of a collision load in the vehicle side collision, suppressing an increase of the vehicle-body weight.

The present invention is a lower structure of a vehicle, comprising a pair of right-and-left side sills extending in a vehicle longitudinal direction and having a closed-cross section, a cross member extending in a vehicle width direction between the pair of side sills, and a reinforcement extending in the vehicle longitudinal direction inside the closed-cross section of each of the pair of side sills and reinforcing the side sill, wherein the reinforcement includes a pair of upper-and-lower lateral wall portions expanding in the vehicle longitudinal direction and in a vehicle width direction and a pair of right-and-left vertical wall portions connecting, in a vertical direction, respective right-side end portions, in the vehicle width direction, of the pair of lateral wall portions and respective left-side end portions, in the vehicle width direction, of the pair of lateral wall portions, and at least one of the pair of lateral wall portions has plural first ridgeline portions which extend in the vehicle width direction and are aligned in the vehicle longitudinal direction, respectively.

According to the present invention, part of the collision load can be absorbed by compressive deformation of the first ridgeline portions in the vehicle wide collision. Further, since the pair of lateral wall portions are connected by the pair of vertical wall portions, the bending deformation of the lateral wall portion caused by the collision load can be suppressed. Thereby, part of the collision load can be transmitted to the cross member. Accordingly, the absorption amount of the collision load can be improved.

Further, since the reinforcement is constituted by the lateral wall portions and the vertical wall portions, the weight increase can be suppressed properly compared to a case where a cylindrical structure extending in the vehicle width direction is applied. The first ridgeline portions do not affect the weight increase of the reinforcement. Accordingly, the lower structure of the present invention can properly improve the absorption amount of the collision load in the vehicle side collision, suppressing the increase of the vehicle-body weight.

In an embodiment of the present invention, the lateral wall portion comprises a first flat-face portion located at a relatively upper side, a second flat-face portion located at a relatively lower side, and a connection portion connecting the first flat-face portion and the second flat-face portion in the vertical direction, and the first ridgeline portions are positioned between the first flat-face portion and the connection portion and between the second flat-face portion and the connection portion, respectively.

According to this embodiment, since the lateral wall portion is comprised of the plural flat faces, the bending deformation can be suppressed. Thereby, the collision load can be transmitted to the cross member properly. Accordingly, the lower structure can improve the absorption amount of the collision load in the vehicle side collision.

In another embodiment of the present invention, the cross member is comprised of plural cross members which are provided to be separated from each other in the vehicle longitudinal direction, and the reinforcement is arranged at a portion inside the side sill which includes an area where the plural cross members are provided.

According to this embodiment, even if the vehicle side collision occurs at a point, in the vehicle longitudinal direction, where the cross members do not exist, the collision load can be transmitted to the cross member via the lateral wall portions. Accordingly, the lower structure can improve the absorption amount of the collision load in the vehicle side collision.

In another embodiment of the present invention, both of the pair of lateral wall portions have the plural first ridgeline portions, respectively.

According to this embodiment, the collision load can be received at the upper-side lateral wall portion and the lower-side lateral wall portion dispersedly. Even if the first ridgeline portions are provided at both the upper-side lateral wall portion and the lower-side lateral wall portion, the weight increase of the reinforcement as a whole is small. Accordingly, the absorption amount of the collision load in the vehicle side collision can be improved, suppressing the increase of the vehicle-body weight.

In another embodiment of the present invention, the plural first ridgeline portions provided at the pair of lateral wall portions are located the same positions in the vehicle longitudinal direction.

According to this embodiment, the collision load can be dispersed to the upper-side lateral wall portion and the lower-side lateral wall portion equally. The lower structure can improve the absorption amount of the collision load in the vehicle side collision.

In another embodiment of the present invention, the cross member includes a ridgeline portion extending in the vehicle width direction, the reinforcement is provided at the same position, in the vehicle longitudinal direction, as the cross member, and part of the plural first ridgeline portions of the lateral wall portion is located at the same level, in the vertical direction, as the ridgeline of the cross member.

According to this embodiment, the transmission efficiency of the collision load from the side sill to the cross member is improved. The lower structure can improve the absorption amount of the collision load in the vehicle side collision.

In another embodiment of the present invention, the pair of lateral wall portions and the pair of vertical wall portions are integrated.

According to this embodiment, the bending deformation of the lateral wall portion can be suppressed easily. Thereby, the lateral wall portion can easily transmit the collision load to the cross member in the vehicle width direction. Consequently, the lower structure can improve the absorption amount of the collision load in the vehicle side collision.

In another embodiment of the present invention, the lateral wall portion has a flange extending in the vertical direction, and the flange is fixed to the side sill.

According to this embodiment, the bending deformation of the lateral wall portion can be suppressed easily. Thereby, the lateral wall portion can easily transmit the collision load to the cross member in the vehicle width direction. Consequently, the lower structure can improve the absorption amount of the collision load in the vehicle side collision.

In another embodiment of the present invention, the lateral wall portion has a second ridgeline portion which extends in the vehicle longitudinal direction at a middle position, in the vehicle width direction, thereof.

According to this embodiment, the bending deformation of the lateral wall portion can be suppressed easily. Thereby, the lateral wall portion can easily transmit the collision load to the cross member in the vehicle width direction. Consequently, the lower structure can improve the absorption amount of the collision load in the vehicle side collision.

As described above, the lower structure of the vehicle according to the present invention can properly improve the absorption amount of the collision load in the vehicle side collision, suppressing the increase of the vehicle-body weight.

The present invention will become apparent from the following description which refers to the accompanying drawings.

### BRIEF DESCRIPTION OF THE DRAWINGS

FIG. 1 is a plan view showing a vehicle body of a vehicle equipped with a lower structure according to an exemplified first embodiment.

FIG. 2 is a perspective view of a right-side side sill, when viewed from an upper right-rear side.

FIG. 3 is a sectional view taken along lone III-III of FIG. 2.

FIG. 4 is a sectional view taken along lone IV-IV of FIG. 2.

FIG. 5 is a perspective view of a reinforcement.

FIG. 6 is a sectional view taken along lone VI-VI of FIG. 3 in a state where the side sill is omitted.

FIG. 7 is a schematic diagram showing a deformation state of the reinforcement in a vehicle side collision.

FIG. 8 is a perspective view of a reinforcement of a lower structure according to a second embodiment.

FIG. 9 is a sectional view showing a fixation structure of the reinforcement and the side sill according to the second embodiment.

FIG. 10 is a perspective view of a reinforcement of a lower structure according to a third embodiment.

FIG. 11 is a perspective view of a reinforcement of a lower structure according to a fourth embodiment.

### DETAILED DESCRIPTION OF THE INVENTION

Hereafter, exemplified embodiments of the present invention will be described specifically referring to the drawings. In the following description, respective positions (directions) of front, rear, left, right, upper and lower relative to a vehicle 1 will be merely referred to as the “front,” “rear,” “left,” “right,” “upper” and “lower.” A lateral direction corresponds to a vehicle width direction.

### First Embodiment

### (1) Whole Structure of Lower Portion of Vehicle

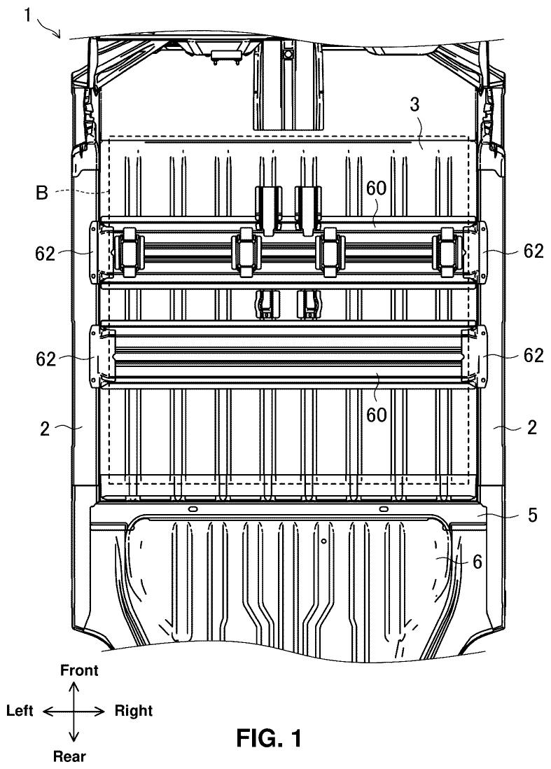

FIG. 1 shows a lower vehicle body of the vehicle 1 provided with a lower structure according to the present embodiment. The vehicle 1 is a four-door type passenger vehicle. In the present embodiment, the vehicle 1 has a laterally-symmetrical vehicle-body structure.

The vehicle 1 comprises a pair of right-and-left side sills 2. Each of the pair of side sills 2 extends straightly in a longitudinal direction. The side sill 2 has a structure having a closed-cross section, and the closed-cross section extends straightly in the longitudinal direction, which will be specifically described later.

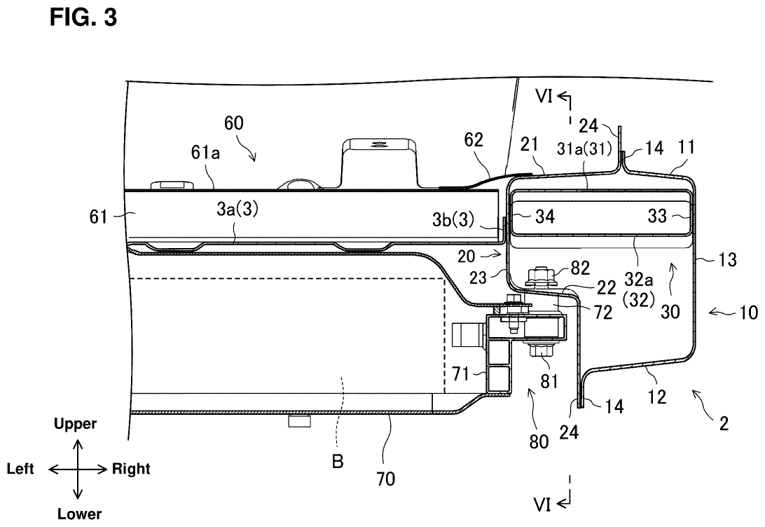

The vehicle 1 comprises a floor panel 3 which forms a floor face of a cabin. The floor panel 3 comprises a floor panel body 3a (see FIGS. 3 and others) which expands in the vehicle width direction and in the longitudinal direction and floor-panel joint portions 3b (see FIGS. 3 and others) which are fixed to the side sills 2 by welding. The left-side floor-panel joint portion 3b is fixedly welded to a right-side portion of the left-side side sill 2. The right-side floor-panel joint portion 3b is fixedly welded to a left-side portion of the right-side side sill 2.

A kick-up portion 5 which rises upward is arranged at a rear end of the floor panel 3. A rear floor panel 6 expands rearward from the kick-up portion 5. The rear floor panel 6 forms a floor face of a luggage room mainly.

Two cross members 60 extending in the lateral direction are arranged above the floor panel 3. The two cross members 60 are aligned such that they are separated from each other in the longitudinal direction. A longitudinal position of the rear-side cross member 60 is the same as that of a center pillar, which is not illustrated.

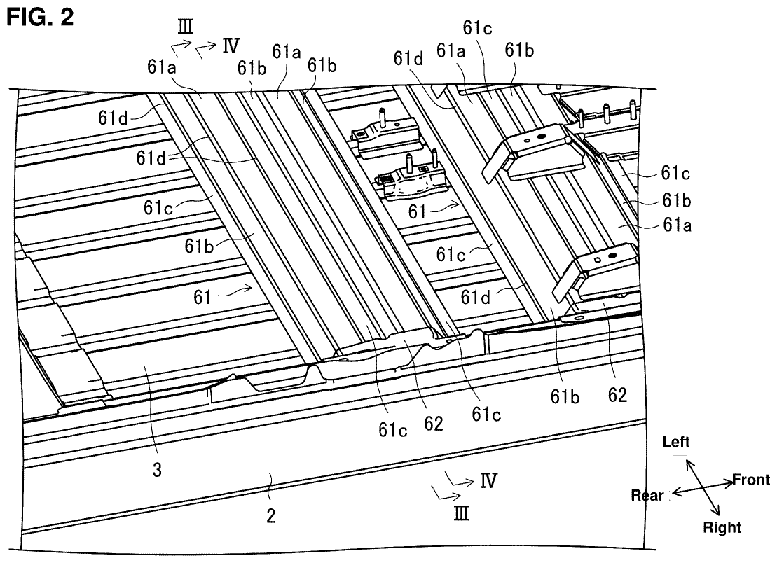

As shown in FIG. 2, the cross member 60 includes a cross-member body 61 and brackets 62. The brackets 62 are fixed to both sides, in the lateral direction, of the cross-member body 61 (the right-side bracket 62 is shown in FIG. 2 only). The left-side bracket 62 is fixed to the left-side side sill 2 by welding, and the right-side bracket 62 is fixed to the right-side side sill 2 by welding. Thereby, the both-side end portions, in the lateral direction, of the cross member 60 are fixed to the side sills 2. A lower end of the cross-member body 61 is fixed to an upper face of the floor panel 3.

The cross-member body 61 has a cross section which is of a M-letter shape. The cross-member body 61 comprises two upper face portions 61a, four side face portions 61b, and a joint face portion 61c which is joined to the floor panel 3. A cross-member ridgeline portion 61d extending in the lateral direction is formed between the upper face portion 61a and the side face portion 61b and also between the joint face portion 61c and the side face portion 61b.

As shown in FIG. 3, a battery B is arranged below the floor panel 3. The battery B is arranged in a state where it is stored in a battery case 70. The battery B is provided in a range which overlaps a roughly whole part of the floor panel 3 in a plan view.

The battery B is supported at lower wall portions (inner lower-wall portions 22 described later) of the side sills 2 together with the battery case 70 via support portions 80. Specifically, a bracket 71 extending outward, in the vehicle width direction, of a vehicle body is fixed to an outward portion, in the vehicle width direction, (to a right-side portion in FIG. 3) of the battery case 70. A bolt 81 is inserted into an outward-side end portion, in the vehicle width direction, (into a right-side end portion in FIG. 3) of the bracket 71. The bolt 81 is supposed to engage with a nut 82 which is fixed to a portion inside the closed-cross section of the inner lower-wall portion 22 of the side sill 2. The bolt 81 is inserted into the bracket 71 from below and fixed by the nut 82. Thereby, the battery B is supported at the side sills 2 via the battery case 70 and the brackets 71. The bolt 81 and the nut 82 constitute a support portion 80. A bush 72 is arranged around the bolt 81 between the bracket 71 and the inner lower-wall portion 22. The bush 72 is made of a resilient member.

### (2) Side Sill

Hereafter, a structure of the side sill 2 will be described specifically. As described above, since the vehicle-body structure of the vehicle 1 is laterally symmetrical, the structure of the right-side side sill 2 will be described specifically, and specific description of the left-side side sill 2 is omitted here. Further, in the description of the right-side side sill 2, the right side corresponds to the outward side, in the vehicle width direction, of the vehicle body and the left side corresponds to the inward side, in the vehicle width direction, of the vehicle body.

### (2-1) Outer Panel, Inner Panel

As shown in FIG. 3, the side sill 2 includes an outer panel 10 positioned on the right side relatively and an inner panel 20 positioned on the left side relatively. A material of the outer panel 10 and the inner panel 21 is not limited to a particular one, but iron is applicable, for example.

The outer panel 10 has a hat-shaped cross section which is open to the left side. The outer panel 10 comprises an outer upper-wall portion 11 which expands in the longitudinal direction and in the lateral direction, an outer lower-wall portion 12 which is provided to face the outer upper-wall portion 11 in a vertical direction and expands in the longitudinal direction and in the lateral direction, and an outer side-wall portion 13 which connects, in the vertical direction, a right-side end portion of the outer upper-wall portion 11 and a right-side end portion of the outer lower-wall portion 12 and expands in the vertical direction and in the longitudinal direction. A pair of outer flanges 14 extend in the vertical direction from a left-side end portion of the outer upper-wall portion 11 and a left-side wall portion of the outer lower-wall portion 12, respectively. The outer upper-wall portion 11 is inclined such that it extends obliquely rightward-and-downward. The outer lower-wall portion 12 is inclined such that it extends obliquely rightward-and-upward. The left-side end portion of the outer upper-wall portion 11 is positioned on the right side of the left-side end portion of the outer lower-wall portion 12.

The inner panel 20 has a hat-shaped cross section which is open to the right side. The inner panel 20 comprises an inner upper-wall portion 21 which expands in the longitudinal direction and in the lateral direction, an inner lower-wall portion 22 which is provided to face the inner upper-wall portion 21 in the vertical direction and expands in the longitudinal direction and in the lateral direction, and an inner side-wall portion 23 which connects, in the vertical direction, a left-side end portion of the inner upper-wall portion 21 and a left-side end portion of the inner lower-wall portion 22 and expands in the vertical direction and in the longitudinal direction. A pair of inner flanges 24 extend in the vertical direction from a right-side end portion of the inner upper-wall portion 21 and a right-side wall portion of the inner lower-wall portion 22, respectively. The inner upper-wall portion 21 is inclined such that it extends obliquely leftward-and-downward. The inner lower-wall portion 22 extends straightly in the lateral direction. The inner lower-wall portion 22 has an insertion hole of the bolt 81.

The outer flanges 14 of the outer panel 10 and the inner flanges 24 of the inner panel 20 are provided to overlap each other in a state where their openings face each other in the lateral direction. The outer flanges 14 and the inner flanges 24 are joined by welding. Thereby, the side sill 2 has the structure having the rectangular-shaped closed-cross section which is formed by the outer upper-wall portion 11, the outer lower-wall portion 12, the outer side-wall portion 13, the inner upper-wall portion 21, the inner lower-wall portion 22, and the inner side-wall portion 23.

The floor panel 3 and the cross member 60 are fixed to the inner panel 20. Specifically, as shown in FIG. 3, the floor-panel joint portion 3b of the floor panel 3 is formed by a right-side end portion of the floor panel body 3a which is bent upward, and extends along the inner side-wall portion 23 and is joined to a left-side face of the inner side-wall portion 23. The bracket 62 of the cross member 60 is provided to cover a corner portion between the inner upper-wall portion 21 and the inner side-wall portion 23. The bracket 62 has a portion for welding which extends continuously along the inner upper-wall portion 21. This welding portion is joined to the inner upper-wall portion 21. Herein, FIG. 3 shows a fixation structure of the rear-side cross member 60 and the inner panel 20. The fixation structure of the front-side cross member 60 and the inner panel 20 are the same as the fixation structure of the rear-side cross member 60 and the inner panel 20.

### (2-2) Reinforcement

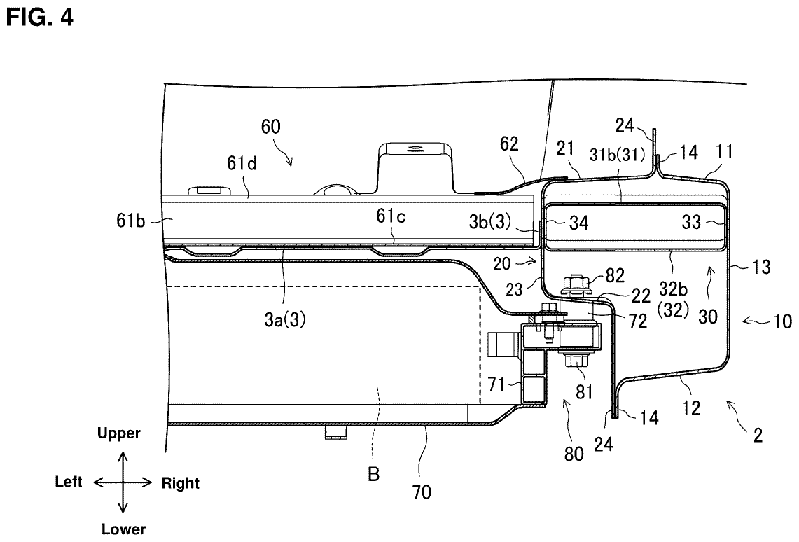

As shown in FIGS. 3 and 4, a reinforcement 30 to reinforce the side sill 2 is arranged inside the closed-cross section of the side sill 2. The reinforcement 30 is formed by pressing of a pipe. The reinforcement 30 extends in the longitudinal direction inside the closed-cross section of the side sill 2. The material strength of the reinforcement 30 is lower than that of the cross-member body 61. Herein, the material strength means the strength of a plate itself which constitutes the member. The material strength is a parameter to be determined by the tensional strength and the thickness of the plate, for example. The higher the tensional strength is, the higher the material strength is. Also, the larger the thickness is, the higher the material strength is. The material of the reinforcement 30 is not limited to a particular one, but it is iron, for example.

The reinforcement 30 is arranged over an entire part of the side sill 2. The reinforcement 30 is seamlessly arranged at a position which corresponds to the cross members 60 and also at an intermediate position between the two cross members 60. The reinforcement 30 is arranged at a position which overlaps the cross members 60 in the vertical direction.

The reinforcement 30 has a structure having a rectangular-shaped closed-cross section. The reinforcement 30 includes an upper-side lateral wall portion 31 which is positioned at a relatively upper side and expands in the longitudinal direction and in the lateral direction and a lower-side lateral wall portion 32 which is provided to face the upper-side lateral wall portion 31 in the vertical direction and expands in the longitudinal direction and in the lateral direction. The reinforcement 30 includes an outward-side vertical wall portion 33 which is positioned at a relatively right side and expands in the longitudinal direction and in the vertical direction and an inward-side vertical wall portion 34 which is provided to face the outward-side vertical wall portion 33 in the lateral direction and expands in the longitudinal direction and in the vertical direction. The outward-side vertical wall portion 33 connects, in the vertical direction, a right-side end portion of the upper-side lateral wall portion 31 and a right-side end portion of the lower-side lateral wall portion 32. The inward-side vertical wall portion 34 connects, in the vertical direction, a left-side end portion of the upper-side lateral wall portion 31 and a left-side end portion of the lower-side lateral wall portion 32. The upper-side lateral wall portion 31, the lower-side lateral wall portion 32, the outward-side vertical wall portion 33, and the inward-side vertical wall portion 34 are made of a single member and formed integrally seamlessly.

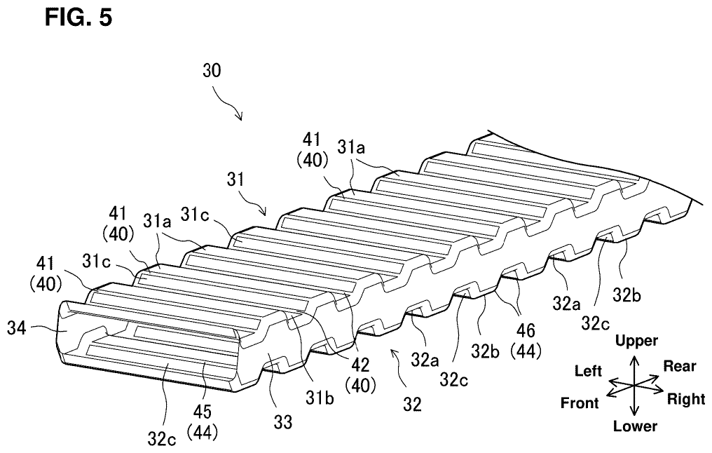

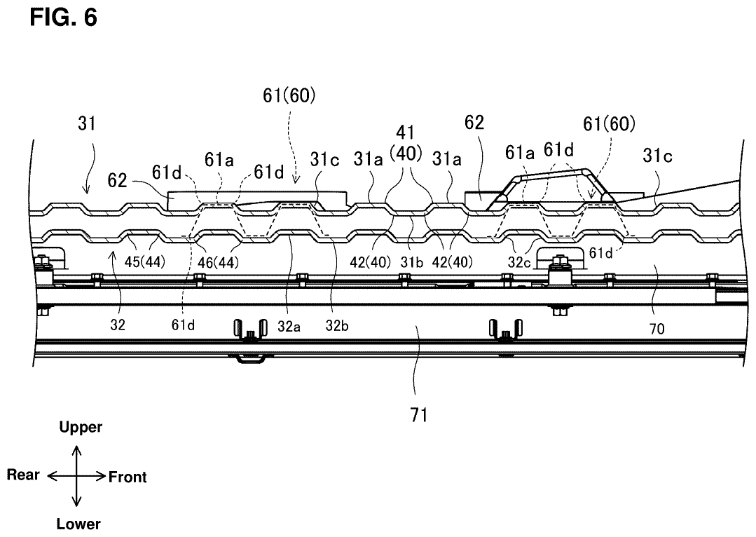

As shown in FIGS. 5 and 6, the upper-side lateral wall portion 31 is of an uneven (concave-and-convex) shape when viewed in the lateral direction. Specifically, the upper-side lateral wall portion 31 comprises a first upper-face portion 31a which is relatively positioned at an upper side and expands in the longitudinal direction and in the lateral direction, a second upper-face portion 31b which is relatively positioned at a lower side and expands in the longitudinal direction and in the lateral direction, and an upper-side connection portion 31c which connects, in the vertical direction, an end portion, in the longitudinal direction, of the first upper-face portion 31a and an end portion, in the longitudinal direction, of the second upper-face portion 31b. The first upper-face portion 31a and the second upper-face portion 31b are aligned in the longitudinal direction alternately. The upper-side connection portion 31c to connect the front-side end portion of the first upper-face portion 31a and the rear-side end portion of the second upper-face portion 31b is inclined such that it expands obliquely forward-and-downward. The upper-side connection portion 31c to connect the rear-side end portion of the first upper-face portion 31a and the front-side end portion of the second upper-face portion 31b is inclined such that it expands obliquely forward-and-upward. The width, in the longitudinal direction, of the first upper-face portion 31a is the same as the width, in the longitudinal direction, of the second upper-face portion 31b. The width, in the longitudinal direction, of the first upper-face portion 31a and the second upper-face portion 31b is narrower than the width, in the longitudinal direction, of the cross member 60 and the minimum of a distance between the pair of cross members 60. Specifically, the width, in the longitudinal direction, of the first upper-face portion 31a and the second upper-face portion 31b is narrower than a half of the width, in the longitudinal direction, of the cross member 60 and also narrower than a half of the minimum of the distance between the pair of cross members 60. The length, in the vertical direction, of the upper-side connection portion 31c, i.e., the distance, in the vertical direction, of the first upper-face portion 31a and the second upper-face portion 31b is about ¼ of the distance between the upper-side lateral wall portion 31 and the lower-side lateral wall portion 32.

Upper-side ridgeline portions 40 extending in the lateral direction are formed between the first upper-face portion 31a and the upper-side connection portion 31c and between the second upper-face portion 31b and the upper-side connection portion 31c, respectively. The upper-side ridgeline portion 40 includes a first upper-side ridgeline portion 41 which is positioned at a front-side end portion or a rear-side end portion of the first upper-face portion 31a and a second upper-side ridgeline portion 42 which is positioned at a front-side end portion or a rear-side end portion of the second upper-face portion 31b. That is, the four upper-side ridgeline portions 40 are formed by one-cycle uneven shape comprising the first upper-face portion 31a, the second upper-face portion 31b, and the upper-side connection portions 31c. The cycle-number of the uneven shape multiplied by four equals the number of the upper-side ridgeline portions 40 which are formed at the upper-side lateral wall portion 31 as a whole.

As shown in FIG. 6, the vertical position of the first upper-face portion 31a is the same as the vertical position of the upper face portion 61a of the cross member 60. Accordingly, the first upper-side ridgeline portion 41 has the same vertical position as the upper-side cross-member ridgeline portion 61d. Further, the first upper-side ridgeline portion 41 has the same longitudinal position as the upper-side cross-member ridgeline portion 61d. The vertical position of the second upper-face portion 31b is located between the upper face portion 61a of the cross member 60 and the floor panel body 3a. Specifically, the vertical position of the second upper-face portion 31b is located at a position which is located above the center between the upper face portion 61a of the cross member 60 and the floor panel body 3a. Accordingly, the vertical position of the second upper-side ridgeline portion 42 is located at a position which is located above the center between the upper face portion 61a of the cross member 60 and the floor panel body 3a.

As shown in FIGS. 5 and 6, the lower-side lateral wall portion 32 is of an uneven (concave-and-convex) shape when viewed in the lateral direction. Specifically, the lower-side lateral wall portion 32 comprises a first lower-face portion 32a which is relatively positioned at an upper side and expands in the longitudinal direction and in the lateral direction, a second lower-face portion 32b which is relatively positioned at a lower side and expands in the longitudinal direction and in the lateral direction, and a lower-side connection portion 32c which connects, in the vertical direction, an end portion, in the longitudinal direction, of the first lower-face portion 32a and an end portion, in the longitudinal direction, of the second lower-face portion 32b. The first lower-face portion 32a and the second lower-face portion 32b are aligned in the longitudinal direction alternately. The lower-side connection portion 32c to connect the front-side end portion of the first lower-face portion 32a and the rear-side end portion of the second lower-face portion 32b is inclined such that it expands obliquely forward-and-downward. The lower-side connection portion 32c to connect the rear-side end portion of the first lower-face portion 32a and the front-side end portion of the second lower-face portion 32b is inclined such that it expands obliquely forward-and-upward. The width, in the longitudinal direction, of the first lower-face portion 32a is the same as the width, in the longitudinal direction, of the second lower-face portion 32b. The width, in the longitudinal direction, of the first lower-face portion 32a and the second lower-face portion 32b is the same as the width, in the longitudinal direction, of the first upper-face portion 31a and the second upper-face portion 31b. The vertical length of the lower-side connection portion 32c, i.e., the distance, in the vertical direction, between the first lower-face portion 32a and the second lower-face portion 32b is the same as the vertical distance between the first upper-face portion 31a and the second upper-face portion 31b.

Lower-side ridgeline portions 44 extending in the lateral direction are formed between the first lower-face portion 32a and the lower-side connection portion 32c and between the second lower-face portion 32b and the lower-side connection portion 32c, respectively. The lower-side ridgeline portion 44 includes a first lower-side ridgeline portion 45 which is positioned at a front-side end portion or a rear-side end portion of the first lower-face portion 32a and a second lower-side ridgeline portion 46 which is positioned at a front-side end portion or a rear-side end portion of the second lower-face portion 32b. That is, the four lower-side ridgeline portions 44 are formed by one-cycle uneven shape comprising the first lower-face portion 32a, the second lower-face portion 32b, and the lower-side connection portions 32c. The cycle-number of the uneven shape multiplied by four equals the number of the lower-side ridgeline portions 44 which are formed at the lower-side lateral wall portion 32 as a whole.

As shown in FIG. 4, the vertical position of the first lower-face portion 32a is above the floor panel body 3a. Accordingly, the vertical position of the first lower-side ridgeline portion 45 is above the floor panel body 3a. The vertical position of the second lower-face portion 32b is the same as the vertical position of the floor panel body 3a. Accordingly, the vertical position of the second lower-side ridgeline 46 is the same as the vertical position of the floor panel body 3a. Further, the vertical position of the second lower-face portion 32b is slightly below the joint face portion 61c of the cross-member body 61. Accordingly, the second lower-side ridgeline portion 46 is slightly below the lower-side cross-member ridgeline portion 61d.

As shown in FIG. 6, the longitudinal position of the first upper-face portion 31a is the same as the longitudinal position of the first lower-face portion 32a. The longitudinal position of the second upper-face portion 31b is the same as the longitudinal position of the second lower-face portion 32b. The longitudinal position of the second upper-side ridgeline portion 42 is the same as the longitudinal position of the second lower-side ridgeline portion 46. Further, the vertical distance between the first upper-face portion 31a and the first lower-face portion 32a, the vertical distance between the second upper-face portion 31b and the second lower-face portion 32b, and the vertical distance between the upper-side connection portion 31c and the lower-side connection portion 32c are the same.

The outward-side vertical wall portion 33 and the inward-side vertical wall portion 34 have the shape corresponding to the uneven shape of the upper-side lateral wall portion 31 and the lower-side lateral wall portion 32. The outward-side vertical wall portion 33 is fixed to the outer side-wall portion 13. The inward-side vertical wall portion 34 is fixed to the inner side-wall portion 23. The respective fixation methods between the outward-side vertical wall portion 33 and the outer side-wall portion 13 and between the inward-side vertical wall portion 34 and the inner side-wall portion 23 are not limited to a particular one, but welding, adhesion by an adhesive agent, bolt fastening or the like are applicable, for example.

An area of the closed-cross section which is formed by the upper-side lateral wall portion 31, the lower-side lateral wall portion 32, the outward-side vertical wall portion 33, and the inward-side vertical wall portion 34 does not change in the longitudinal direction.

### (3) Operation (Movement) in Vehicle Side Collision

The reinforcement 30 absorbs part of the collision load in the vehicle side collision and transmits the rest of the collision load to the cross members 60 and the floor panel 3, in particular.

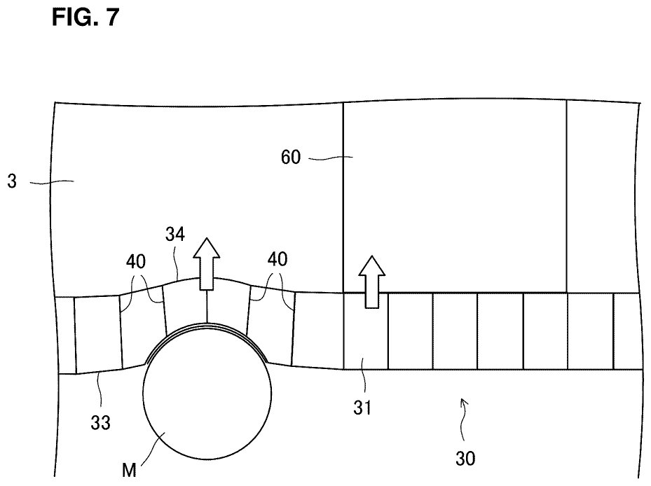

FIG. 7 shows a deformation state of the reinforcement 30 in the vehicle side collision. Herein, a case where a collision object M hits against a section positioned on the rearward side of the cross member 60 is assumed.

When the collision object M comes in toward the inside of the cabin in the vehicle side collision as shown in FIG. 7, part of the reinforcement 30 is compressively deformed. Since the reinforcement 30 has the plural upper-side ridgeline portions 40 and the plural lower-side ridgeline portions 44, its rigidity against the collision load in the lateral direction is rather high. Accordingly, a portion of the reinforcement 30 which receives the large collision load, i.e., is close to an application point of the collision load, is compressively deformed. Thereby, part of the collision load is absorbed.

Meanwhile, another portion of the reinforcement 30 which is located on the inward side, in the vehicle width direction, thereof, i.e., is away from the application point of the collision load, is pushed toward the inward side, in the vehicle width direction, thereof. Herein, the bending deformation of the upper-side lateral wall portion 31 and the lower-side lateral wall portion 32 is suppressed. Thereby, the reinforcement 30 is moved to the inward side, in the vehicle width direction, of the vehicle body as a whole. Consequently, the collision load is transmitted to the cross member 60 via the reinforcement 30.

As described above, in the vehicle side collision, the reinforcement 30 can absorb the collision load applied to the side sill 2 properly and also transmit the collision load to the cross member 60 and the like properly.

### (4) Effects of First Embodiment

In the first embodiment, the lower structure of the vehicle 1 comprises the reinforcement 30 which extends in the vehicle longitudinal direction inside the closed-cross section of each of the pair of side sills 2 and reinforces the side sill 2. The reinforcement 30 includes the upper-and-lower lateral wall portions 31, 32 which expand in the vehicle longitudinal direction and in the vehicle width direction and the outward-side and inward-side vertical wall portions 33, 34 which connect, in the vertical direction, the right-side and left-side end portions of the upper-and-lower lateral wall portions 31, 32. The upper-and-lower lateral wall portions 31, 32 have the upper-side and lower-side ridgeline portions 40, 44 which extend in the vehicle width direction and are aligned in the vehicle longitudinal direction, respectively. Accordingly, part of the collision load can be absorbed by the compressive deformation of the upper-side and lower-side ridgeline portions 40, 44 in the vehicle wide collision. Further, since the upper-and-lower lateral wall portions 31, 32 are connected by the outward-side and inward-side vertical wall portions 33, 34, the bending deformation of the upper-and-lower lateral wall portions 31, 32 caused by the collision load can be suppressed. Thereby, part of the collision load can be transmitted to the cross member 60. Further, since the reinforcement 30 is constituted by the upper-and-lower lateral wall portions 31, 32 and the outward-side and inward-side vertical wall portions 33, 34 and any wall portion expanding in the vertical direction and in the vehicle width direction is unnecessary, the weight increase can be suppressed compared to a case where a cylindrical structure extending in the vehicle width direction is applied. Also, since the upper-side and lower-side ridgeline portions 40, 44 are formed just by applying the bending process to the upper-and-lower lateral wall portions 31, 32, the weight increase of the reinforcement 30 can be suppressed properly even if the upper-side and lower-side ridgeline portions 40, 44 are provided. Thus, the first embodiment can properly improve the absorption amount of the collision load in the vehicle side collision, suppressing the increase of the vehicle-body weight.

In particular, according to the first embodiment, the collision load can be dispersedly received at the upper-and-lower lateral wall portions 31, 32 because both the upper-and-lower lateral wall portions 31, 32 have the ridgeline portions. The first embodiment can improve the absorption amount of the collision load in the vehicle side collision properly.

In the first embodiment, the upper-side lateral wall portion 31 comprises the first upper-face portion 31a located at the relatively upper side, the second upper-face portion 31b located at the relatively lower side, and the upper-side connection portion 31c connecting the first upper-face portion 31a and the second upper-face portion 31b in the vertical direction. The upper-side ridgeline portions 40 are positioned between the first upper-face portion 31a and the upper-side connection portion 31c and between the second upper-face portion 31b and the upper-side connection portion 31c, respectively. Further, the lower-side lateral wall portion 32 comprises the first lower-face portion 32a located at the relatively upper side, the second lower-face portion 32b located at the relatively lower side, and the lower-side connection portion 32c connecting the first lower-face portion 32a and the second lower-face portion 32b in the vertical direction. The lower-side ridgeline portions 44 are positioned between the first lower-face portion 32a and the lower-side connection portion 32c and between the second lower-face portion 32b and the lower-side connection portion 32c, respectively. According to this embodiment, since the upper-side lateral wall portion 31 and the lower-side lateral wall portion 32 are comprised of the plural flat faces, the bending deformation can be suppressed. Thereby, the collision load can be transmitted to the cross member 60. Moreover, since the upper-side ridgeline portions 40 and the lower-side ridgeline portions 44 are composed of many ridgelines, the energy absorption by means of the axial compression can be improved. Accordingly, the first embodiment can improve the absorption amount of the collision load in the vehicle side collision.

In the first embodiment, the plural cross members 60 are provided to be separated from each other in the vehicle longitudinal direction, and the reinforcement 30 is arranged at the portion inside the side sill 2 which includes an area where the plural cross members 60 are provided. Accordingly, even if the vehicle side collision occurs at a point, in the vehicle longitudinal direction, where the cross members 60 do not exist, the collision load can be transmitted to the cross member 60 via the lateral wall portions because the bending deformation is suppressed. Accordingly, the first embodiment can improve the absorption amount of the collision load in the vehicle side collision.

In the first embodiment, the upper-side ridgeline portion 40 and the lower-side ridgeline portion 44 are located the same positions in the vehicle longitudinal direction. Accordingly, the collision load can be dispersed to the upper-side lateral portion 31 and the lower-side lateral portion 32 equally. The first embodiment can improve the absorption amount of the collision load in the vehicle side collision.

In the first embodiment, the cross member 60 includes the cross-member ridgeline portion 61d extending in the vehicle width direction. The reinforcement 30 is provided at the same position, in the vehicle longitudinal direction, as the cross member 60. Part of the upper-side ridgeline portions 40 of the upper-side lateral wall portion 31 (the first upper-side ridgeline portion 41) is located at the same level, in the vertical direction, as the upper-side cross-member ridgeline portion 61d. Accordingly, the transmission efficiency of the collision load from the side sill 2 to the cross member 60 is improved. The first embodiment can improve the absorption amount of the collision load in the vehicle side collision.

In the first embodiment, the pair of lateral wall portions 31, 32 and the pair of vertical wall portions 33, 34 are integrated seamlessly. Accordingly, the bending deformation of these lateral wall portions 31, 32 can be suppressed easily. Thereby, these lateral wall portions 31, 32 can easily transmit the collision load to the cross member 60 in the vehicle width direction. Further, the weight increase of the reinforcement 30 can be suppressed compared to a case where the lateral wall portions 31, 32 and the vertical wall portions 33, 34 are all made of separated (different) members. Consequently, the first embodiment can improve the absorption amount of the collision load in the vehicle side collision, suppressing the increase of the vehicle-body weight.

In the first embodiment, part of the lower-side ridgeline portions 44 of the lower-side lateral wall portion 32 (the second lower-side ridgeline portion 46) is located at the same level, in the vertical direction, as the floor panel 3. Accordingly, part of the collision load in the vehicle side collision can be transmitted to the floor panel 3 efficiently. Further, since it is suppressed by the floor panel 3 that the reinforcement 30 comes in to the inward side, in the vehicle width direction, of the vehicle body, the bending deformation of the reinforcement 30 is suppressed. Consequently, the transmission efficiency of the collision load from the side sill d2 to the cross member 60 is improved. The first embodiment can properly transmit the collision load applied to the side sill 2 in the vehicle side collision.

### Second Embodiment

Hereafter, a second embodiment will be described specifically referring to the drawings. Herein, the same structures as the above-described first embodiment have the same reference characters and their detailed description is omitted here.

### (5) Reinforcement

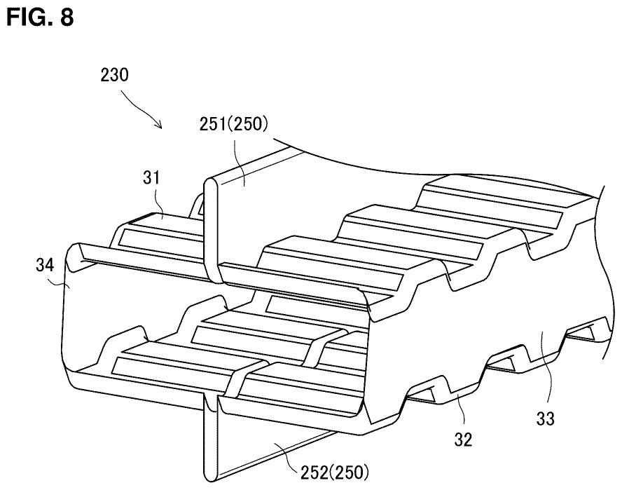

The shape of a reinforcement 230 of the second embodiment is different from the first embodiment. Specifically, as shown in FIG. 8, the reinforcement 230 has plural flanges 250 which expand in the longitudinal direction and in the vertical direction at a middle portion, in the vehicle width direction, thereof. The plural flanges 250 comprise an upper-side flange 251 which extends upward from the upper-side lateral wall portion 31 and a lower-side flange 252 which extends downward from the lower-side lateral wall portion 32.

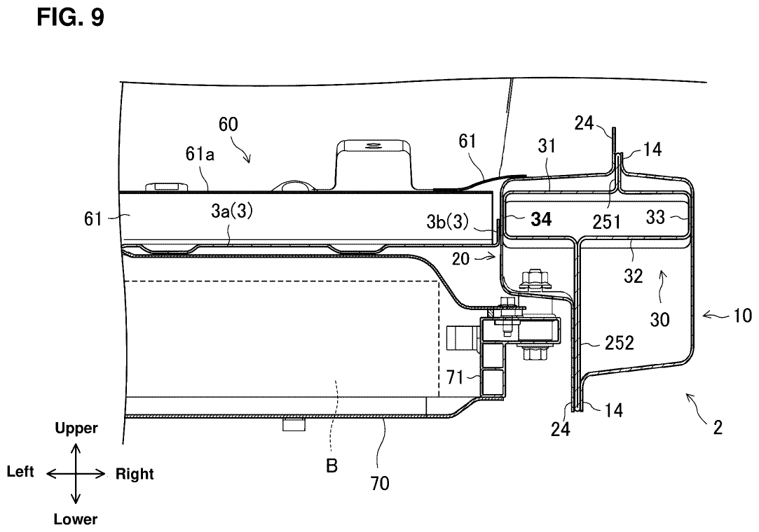

As shown in FIG. 9, the upper-side flange 251 is located at a position of the upper-side outer flange 14 and the upper-side inner flange 24. The upper-side flange 251 is laterally interposed between the upper-side outer flange 14 and the upper-side inner flange 24. Thereby, the upper-side flange 251 is fixed to the side sill 2.

The lower-side flange 252 is located at a position of the lower-side outer flange 14 and the lower-side inner flange 24. The lower-side flange 252 is laterally interposed between the lower-side outer flange 14 and the lower-side inner flange 24. Thereby, the lower-side flange 252 is fixed to the side sill 2.

### (6) Effects of Second Embodiment

In the second embodiment, the bending deformation of the upper-side lateral wall portion 31 can be suppressed easily by the upper-side flange 251. Further, the bending deformation of the lower-side lateral wall portion 32 can be suppressed easily by the lower-side flange 252. Thereby, these lateral wall portions 31, 32 can easily transmit the collision load to the cross member 60 in the vehicle width direction. Consequently, the second embodiment can improve the absorption amount of the collision load in the vehicle side collision, suppressing the increase of the vehicle body.

Further, in the second embodiment, the upper-side flange 251 and the lower-side flange 252 are interposed, in the vehicle width direction, between the outer flange 14 and the inner flange 24 and fixed to the side sill 2. Thereby, the bending deformation of the upper-side and lower-side lateral wall portions 31, 32 can be suppressed effectively, so that these lateral wall portions 31, 32 easily transmit the collision load to the cross member 60 in the vehicle width direction. The second embodiment 2 can improve the absorption amount of the collision load in the vehicle side collision.

### Third Embodiment

Hereafter, a third embodiment will be described specifically referring to the drawings. Herein, the same structures as the above-described first and second embodiments have the same reference characters and their detailed description is omitted here.

### (7) Reinforcement

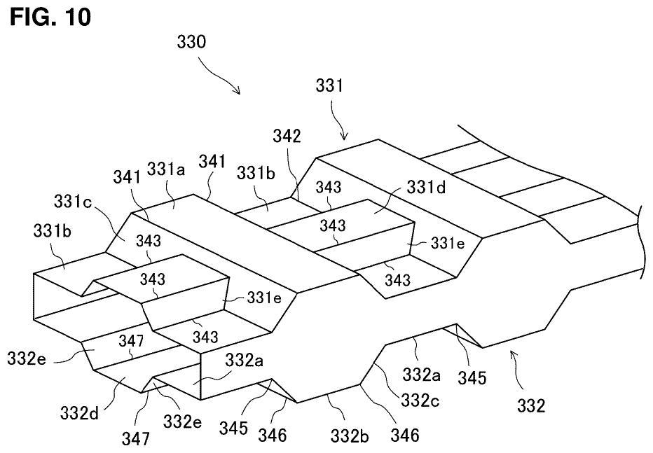

The shape of a reinforcement 330 of the third embodiment is different from the first and second embodiments. Specifically, as shown in FIG. 10, the reinforcement 330 has a third upper-face portion 331d extending in the longitudinal direction at a middle position, in the lateral direction, of the upper-side lateral wall portion 331. Further, the reinforcement 330 has a third lower-face portion 332d extending in the longitudinal direction at a middle position, in the lateral direction, of the lower-side lateral wall portion 332.

The vertical position of the third upper-face portion 331d is located between the first upper-face portion 331a and the second upper-face portion 331b. Between the third upper-face portion 331d and the second upper-face portion 331b is formed a second upper-side connection portion 331e which connects these upper-face portions 331d, 331b in the vertical direction.

Third upper-side ridgeline portions 343 extending in the longitudinal direction are positioned between the third upper-face portion 331d and the second upper-side connection portion 331e and between the second upper-face portion 331b and the second upper-side connection portion 331e. The third upper-side ridgeline portion 343 is located at a middle position, in the lateral direction, of the upper-side lateral wall portion 331. The third upper-side ridgeline portion 343 extends in a direction perpendicular to a first upper-side ridgeline portion 341 and a second upper-side ridgeline portion 342. A ridgeline portion extending in the lateral direction is positioned between the third upper-face portion 331d and the upper-side connection portion 331c.

The vertical position of the third lower-face portion 332d is located between the first lower-face portion 332a and the second lower-face portion 332b. Between the third lower-face portion 332d and the second lower-face portion 332b is formed a second lower-side connection portion 332e which connects these lower-face portions 332d, 332b in the vertical direction.

Third lower-side ridgeline portions 347 extending in the longitudinal direction are positioned between the third lower-face portion 332d and the second lower-side connection portion 332e and between the second lower-face portion 332b and the second lower-side connection portion 332e. The third lower-side ridgeline portion 347 is located at a middle position, in the lateral direction, of the lower-side lateral wall portion 332. The third lower-side ridgeline portion 347 extends in a direction perpendicular to a first lower-side ridgeline portion 345 and a second lower-side ridgeline portion 346. A ridgeline portion extending in the lateral direction is positioned between the third lower-face portion 332d and the lower-side connection portion 332c, which is not specifically illustrated.

The position, in the lateral direction, of the third upper-face portion 331d and the position, in the lateral direction, of the third lower-face portion 332d are the same. The position, in the lateral direction, of the third upper-side ridgeline portion 343 and the position, in the lateral direction, of the third lower-side ridgeline portion 347 are the same.

### (8) Effects of Third Embodiment

In the third embodiment, the bending deformation of the upper-side lateral wall portion 331 can be suppressed effectively by the third upper-side ridgeline portion 343. Also, the bending deformation of the lower-side lateral wall portion 332 can be suppressed effectively by the third lower-side ridgeline portion 347. Thereby, these lateral wall portions 331, 332 can easily transmit the collision load to the cross member 60 in the vehicle width direction.

Consequently, the third embodiment can improve the absorption amount of the collision load in the vehicle side collision, suppressing the increase of the vehicle-body weight.

### Fourth Embodiment

Hereafter, a fourth embodiment will be described specifically referring to the drawings. Herein, the same structures as the above-described first through third embodiments have the same reference characters and their detailed description is omitted here.

### (9) Reinforcement

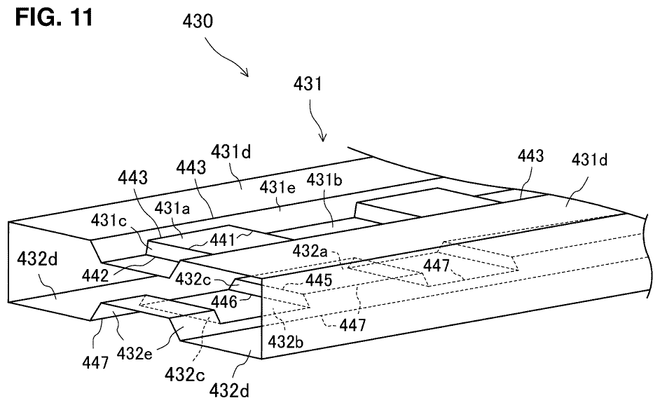

The shape of a reinforcement 430 of the fourth embodiment is different from the first through third embodiments. Specifically, as shown in FIG. 11, the reinforcement 430 has fourth upper-face portions 431d extending in the longitudinal direction at both-side portions, in the lateral direction, of an upper-side lateral wall portion 431, respectively. Further, the reinforcement 430 has fourth lower-face portions 432d extending in the longitudinal direction at both-side portions, in the lateral direction, of a lower-side lateral wall portion 432, respectively.

The vertical position of the fourth upper-face portion 431d is above a first upper-face portion 431a. A third upper-side connection portion 431e which connects the fourth upper- face portion 431d, a first upper-face portion 431a, a second upper-face portion 431b, and an upper-side connection portion 431c in the vertical direction is formed among the fourth upper-face portion 431d, the first upper-face portion 431a, and the second upper-face portion 431b.

Fourth upper-side ridgeline portions 443 extending in the longitudinal direction are positioned between the fourth upper-face portion 431d and the third upper-side connection portion 431e and between the first upper-face portion 431a and the third upper-side connection portion 431e. The upper-side ridgeline portion 443 is located at a middle position, in the lateral direction, of the upper-side lateral wall portion 431. The upper-side ridgeline portion 443 extends in a direction perpendicular to a first upper-side ridgeline portion 441 and a second upper-side ridgeline portion 442.

The vertical position of a fourth lower-face portion 432d is below a first lower-face portion 432a. A third lower-side connection portion 432e which connects a fourth lower-face portion 432d, a first lower-face portion 432a, a second lower-face portion 432b, and a lower-side connection portion 432c in the vertical direction is formed among the fourth lower-face portion 432d, the first lower-face portion 432a, and the second lower-face portion 432b.

Fourth lower-side ridgeline portions 447 extending in the longitudinal direction are positioned between the fourth lower-face portion 432d and the third lower-side connection portion 432e and between the first lower-face portion 432a and the third lower-side connection portion 432e. The lower-side ridgeline portion 447 is located at a middle position, in the lateral direction, of the lower-side lateral wall portion 432. The lower-side ridgeline portion 447 extends in a direction perpendicular to a first lower-side ridgeline portion 445 and a second lower-side ridgeline portion 446.

### (10) Effects of Fourth Embodiment

In the fourth embodiment, the bending deformation of the upper-side lateral wall portion 431 can be suppressed effectively by the fourth upper-side ridgeline portion 443. Also, the bending deformation of the lower-side lateral wall portion 432 can be suppressed effectively by the fourth lower-side ridgeline portion 447. Thereby, these lateral wall portions 431, 432 can easily transmit the collision load to the cross member 60 in the vehicle width direction. Consequently, the fourth embodiment can improve the absorption amount of the collision load in the vehicle side collision, suppressing the increase of the vehicle-body weight.

Further, in the fourth embodiment, when the reinforcement 430 is compressively deformed in the lateral direction in the vehicle side collision, the second upper-face portion 431b and the first lower-face portion 432a approach each other in the vertical direction and contact each other. Thereby, it can be suppressed that the reinforcement 430 is compressively deformed excessively, so that the collision load can be properly transmitted to the inward side, in the vehicle width direction, of the vehicle body. Accordingly, the fourth embodiment can properly transmit the collision load applied to the side sill 2 in the vehicle side collision.

### Other Embodiments

The present invention is not limited to the above-described embodiments and any other modifications are applicable within a scope of the claims.

While the ridgeline portions are formed at the upper-side lateral wall portions 31, 331, 431 and the lower-side lateral wall portions 32, 332, 432, respectively in the above-described first through fourth embodiments, either one of these lateral wall portions 31, 331, 431 and 32, 332, 432 may have the ridgeline portions.

In the above-described first through fourth embodiments, the longitudinal positions of the upper-side ridgeline portions 40, 341, 441, 342, 442 are the same as the longitudinal positions of the lower-side ridgeline portions 44, 345, 445, 346, 446. However, these longitudinal positions are different in the longitudinal direction.

In the above-described first through fourth embodiments, the upper-side lateral wall portions 31, 331, 431 and the lower-side lateral wall portions 32, 332, 432, and the outward-side vertical wall portion 33 and the inward-side vertical wall portion 34 are integrated. However, these may be separated. In this case, the outward-side vertical wall portion 33 and the inward-side vertical wall portion 34 may be joined to the upper-side lateral wall portions 31, 331, 431 and the lower-side lateral wall portions 32, 332, 432 by welding or adhesive agent.

The above-described embodiments merely exemplify the lower structure of the vehicle according to the present invention, and therefore the present invention is not limited by these embodiments. Any modifications which are specified in the claims and also construed under the doctrine of equivalents should be within the scope of the present invention.

The present invention described above is useful as the lower structure of the vehicle.

What is claimed is:

1. A lower structure of a vehicle, comprising:
a pair of right-and-left side sills extending in a vehicle longitudinal direction and having a closed-cross section;
a cross member extending in a vehicle width direction between the pair of side sills; and
a reinforcement extending in the vehicle longitudinal direction inside the closed-cross section of each of the pair of side sills and reinforcing the side sill,
wherein said reinforcement includes a pair of upper-and-lower lateral wall portions expanding in the vehicle longitudinal direction and in a vehicle width direction and a pair of right-and-left vertical wall portions connecting, in a vertical direction, respective right-side end portions, in the vehicle width direction, of said pair of lateral wall portions and respective left-side end portions, in the vehicle width direction, of said pair of lateral wall portions, and at least one of said pair of lateral wall portions has plural first ridgeline portions which extend in the vehicle width direction and are aligned in the vehicle longitudinal direction, respectively.

2. The lower structure of the vehicle of claim 1, wherein said lateral wall portion comprises a first flat-face portion located at a relatively upper side, a second flat-face portion located at a relatively lower side, and a connection portion connecting said first flat-face portion and said second flat-face portion in the vertical direction, and said first ridgeline portions are positioned between said first flat-face portion and said connection portion and between said second flat-face portion and said connection portion, respectively.

3. The lower structure of the vehicle of claim 1, wherein said cross member is comprised of plural cross members which are provided to be separated from each other in the vehicle longitudinal direction, and said reinforcement is arranged at a portion inside the side sill which includes an area where said plural cross members are provided.

4. The lower structure of the vehicle of claim 1, wherein both of said pair of lateral wall portions have said plural first ridgeline portions, respectively.

5. The lower structure of the vehicle of claim 4, wherein said plural first ridgeline portions provided at said pair of lateral wall portions are located the same positions in the vehicle longitudinal direction.

6. The lower structure of the vehicle of claim 1, wherein said cross member includes a ridgeline portion extending in the vehicle width direction, said reinforcement is provided at the same position, in the vehicle longitudinal direction, as the cross member, and part of said plural first ridgeline portions of the lateral wall portion is located at the same level, in the vertical direction, as said ridgeline of the cross member.

7. The lower structure of the vehicle of claim 1, wherein said pair of lateral wall portions and said pair of vertical wall portions are integrated.

8. The lower structure of the vehicle of claim 1, wherein said lateral wall portion has a flange extending in the vertical direction, and said flange is fixed to said side sill.

9. The lower structure of the vehicle of claim 1, wherein said lateral wall portion has a second ridgeline portion which extends in the vehicle longitudinal direction at a middle position, in the vehicle width direction, thereof.

10. The lower structure of the vehicle of claim 2, wherein said cross member is comprised of plural cross members which are provided to be separated from each other in the vehicle longitudinal direction, and said reinforcement is arranged at a portion inside the side sill which includes an area where said plural cross members are provided.

11. The lower structure of the vehicle of claim 2, wherein both of said pair of lateral wall portions have said plural first ridgeline portions, respectively.

12. The lower structure of the vehicle of claim 2, wherein said cross member includes a ridgeline portion extending in the vehicle width direction, said reinforcement is provided at the same position, in the vehicle longitudinal direction, as the cross member, and part of said plural first ridgeline portions of the lateral wall portion is located at the same level, in the vertical direction, as said ridgeline of the cross member.

13. The lower structure of the vehicle of claim 2, wherein said pair of lateral wall portions and said pair of vertical wall portions are integrated.

14. The lower structure of the vehicle of claim 2, wherein said lateral wall portion has a flange extending in the vertical direction, and said flange is fixed to said side sill.

15. The lower structure of the vehicle of claim 2, wherein said lateral wall portion has a second ridgeline portion which extends in the vehicle longitudinal direction at a middle position, in the vehicle width direction, thereof.

16. The lower structure of the vehicle of claim 5, wherein said cross member includes a ridgeline portion extending in the vehicle width direction, said reinforcement is provided at the same position, in the vehicle longitudinal direction, as the cross member, and part of said plural first ridgeline portions of the lateral wall portion is located at the same level, in the vertical direction, as said ridgeline of the cross member.

17. The lower structure of the vehicle of claim 5, wherein said pair of lateral wall portions and said pair of vertical wall portions are integrated.

18. The lower structure of the vehicle of claim 5, wherein said lateral wall portion has a flange extending in the vertical direction, and said flange is fixed to said side sill.

19. The lower structure of the vehicle of claim 5, wherein said lateral wall portion has a second ridgeline portion which extends in the vehicle longitudinal direction at a middle position, in the vehicle width direction, thereof.
